(19) United States
(12) Patent Application Publication
(10) Pub. No.: US 2026/0277136 A1
(43) Pub. Date: Sep. 17, 2026

(54) DEVELOPING DEVICE AND IMAGE FORMING APPARATUS

(71) Applicant: FUJIFILM Business Innovation Corp., Tokyo (JP)

(72) Inventors: Yuka NOMURA, Kanagawa (JP); Tatsuro MATSUOKA, Kanagawa (JP); Kazunari ISHII, Kanagawa (JP); Narumi NAKAYA, Kanagawa (JP); Maho ITAKURA, Kanagawa (JP); Natsuki OGAWA, Kanagawa (JP)

(73) Assignee: FUJIFILM Business Innovation Corp., Tokyo (JP)

(21) Appl. No.: 19/298,141

(22) Filed: Aug. 12, 2025

(30) Foreign Application Priority Data
Mar. 12, 2025 (JP) 2025-039482

(51) Int. Cl. G03G 15/08; G03G 21/20

(52) U.S. Cl. CPC G03G 15/0896; G03G 21/20

(57) ABSTRACT

A developing device that is composed of plural constituent members and that causes a developer to adhere to an image holding body holding an image includes an opening that is disposed in a state of facing an image holding body side, a blocking member that partially blocks the opening, and another opening that extends in a direction intersecting a surface of the opening and that is disposed on an opposite side to, with respect to the blocking member, a side on which the image holding body is installed, in which air on the opposite side is dischargeable through the other opening.

### CROSS-REFERENCE TO RELATED APPLICATIONS

This application is based on and claims priority under 35 USC 119 from Japanese Patent Application No. 2025-039482 filed March 12, 2025.

### BACKGROUND

### Technical Field

The present invention relates to a developing device and an image forming apparatus.

### Related Art

For example, disclosed in JP1997-160459A is a configuration in which a cloud collection housing, of which a cloud collection opening is open to correspond to at least a portion of a development opening edge of a development housing that extends along a width direction of a latent image carrier is provided. In such a configuration, a suction force applying unit that applies a suction force to a toner cloud in a direction from the cloud collection opening to the inside of the cloud collection housing is provided. In addition, in such a configuration, a suction force distribution setting unit, in which a suction force with respect to the toner cloud at a portion of the cloud collection opening that corresponds to a region through which a transfer medium having a standard size set in advance passes through is set to be larger than a suction force at other portions of the cloud collection opening, is provided.

### SUMMARY

In an image forming apparatus, development may be performed by using a developing device, so that an image is formed. Here, in a case where there is a position in the developing device at which it is difficult for air to flow, a developer is likely to be stagnant at the position. In a case where stagnation of the developer occurs, a problem such as a development failure is likely to occur.

Aspects of non-limiting embodiments of the present disclosure relate to a developing device and an image forming apparatus that lower the probability of stagnation of a developer in a developing device in comparison with a configuration in which there is a position at which it is difficult for air to flow.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing device that is composed of a plurality of constituent members and that causes a developer to adhere to an image holding body holding an image, the developing device including an opening that is disposed in a state of facing an image holding body side, a blocking member that partially blocks the opening, and another opening that extends in a direction intersecting a surface of the opening and that is disposed on an opposite side to, with respect to the blocking member, a side on which the image holding body is installed, in which air on the opposite side is dischargeable through the other opening.

### BRIEF DESCRIPTION OF THE DRAWINGS

Exemplary embodiment(s) of the present invention will be described in detail based on the following figures, wherein:

FIG. 1 is a view illustrating an image forming apparatus;

FIG. 2 is a view of a developing device as seen from above;

FIG. 3 is a cross-sectional view of the developing device taken along line III-III in FIG. 2;

FIG. 4 is a cross-sectional view of the developing device taken along line IV-IV in FIG. 2;

FIG. 5 is a cross-sectional view of the developing device taken along line V-V in FIG. 2;

FIG. 6 is an explanatory view for description of a developer suction mechanism in the developing device;

FIG. 7 is a view showing how one end portion of the developing device is in a case where the one end portion is seen in a direction represented by an arrow VII in FIG. 2;

FIG. 8 is a perspective view showing one end portion side of the developing device as seen from the other end portion side of the developing device;

FIG. 9 is a perspective view showing the one end portion of the developing device as seen in a direction represented by an arrow IX in FIG. 7;

FIG. 10 is a view of the developing device as seen from below;

FIG. 11 is a perspective view of a cross section of the developing device taken along line XI-XI of FIG. 7;

FIGS. 12A and 12B are views for comparison between the sizes of a first opening and a second opening, where FIG. 12A is a view showing the first opening and FIG. 12B is a view showing the second opening;

FIG. 13 is an explanatory view for description of another developer suction mechanism in the developing device;

FIGS. 14A to 14C are views and a graph showing how air sucked in the vicinity of a blocking member in the developing device flows;

FIGS. 15A to 15D are views and a graph for description of the shape of an opening portion, where FIGS. 15A to 15C show various examples of an opening shape and FIG. 15D is a graph showing the amounts of collected toner in the cases of FIGS. 15A to 15C, respectively;

FIGS. 16A to 16C are views for description of a positional relationship between a seal roll and the opening portion, where FIG. 16A shows a first example, FIG. 16B shows a second example, and FIG. 16C shows a third example; and

FIG. 17 is a view for description of a modification example of the developing device.

### DETAILED DESCRIPTION

Hereinafter, an exemplary embodiment of the present invention will be described in detail with reference to the accompanying drawings.

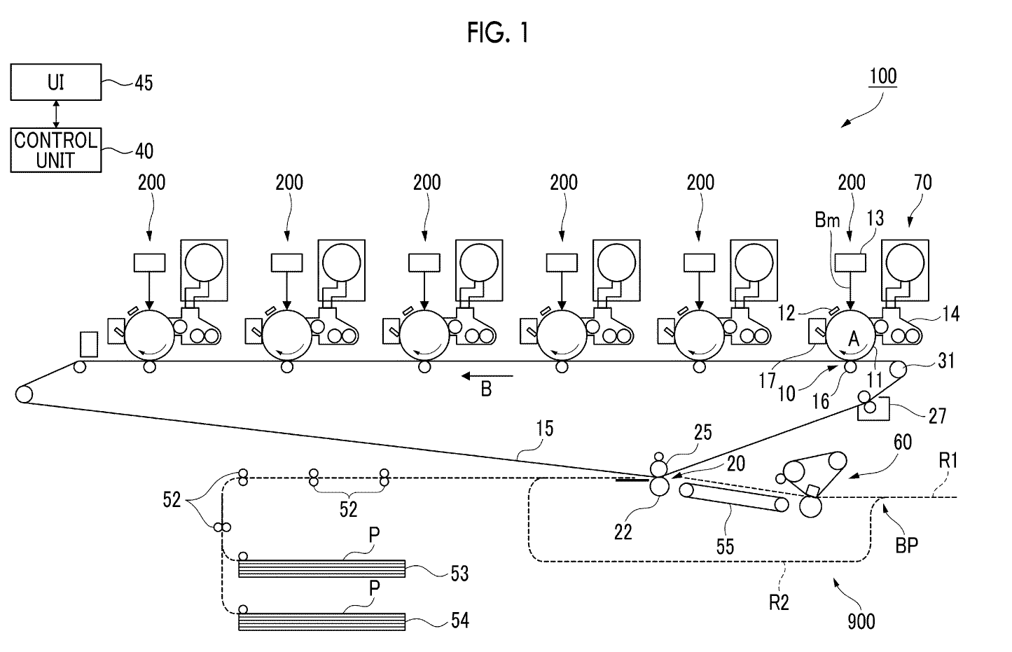

FIG. 1 is a view showing an image forming apparatus 100 according to the present exemplary embodiment. FIG. 1 shows a state related to a case where the image forming apparatus 100 is seen from a side ahead of the image forming apparatus 100.

The image forming apparatus 100 is an intermediate transfer type image forming apparatus 100, which is called a tandem type image forming apparatus.

The image forming apparatus 100 is provided with a plurality of image forming units 200 that form images to be transferred to a paper sheet P, which is an example of a recording medium.

Each of the image forming units 200 includes a photoreceptor drum 11 which is an example of an image holding body. Each of the image forming units 200 forms a toner image, which is an image to be transferred to the paper sheet P, on the photoreceptor drum 11 by using a developer containing toner. In other words, each of the image forming units 200 forms, on the photoreceptor drum 11 by using a powdery developer, a toner image to be transferred to the paper sheet P.

A developer of the present exemplary embodiment is composed of a dry carrier and dry toner. Each of the image forming units 200 uses a carrier and toner to form a toner image on the photoreceptor drum 11.

Six image forming units 200 form toner images on the photoreceptor drums 11 by using different types of developers.

Specifically, in the present exemplary embodiment, four of the six image forming units 200 form toner images by using developers of basic colors which are yellow, magenta, cyan, and black.

In addition, the remaining two image forming units 200 form toner images by using a developer of a color other than the basic colors, such as clear, white, gold, silver, pink, green, or orange.

Note that examples of the developer of a color other than the basic colors include a developer containing magnetic toner and a developer containing conductive toner, in addition to the above-described developer. In addition, examples of the developer of a color other than the basic colors include a developer containing toner that emits light in a case where the toner is irradiated with light such as ultraviolet rays or infrared rays.

In the present exemplary embodiment, a so-called two-component developer in which a carrier and toner are mixed with each other is used as the developer. However, the developer is not limited thereto. That is, as the developer, a so-called one-component developer composed of toner alone may also be used.

In addition, the image forming apparatus 100 is provided with an intermediate transfer belt 15. In addition, the image forming apparatus 100 is provided with primary transfer units 10 provided to transfer toner images to the intermediate transfer belt 15, the toner images being respectively formed by the image forming units 200.

Furthermore, the image forming apparatus 100 is provided with a secondary transfer unit 20 provided to transfer, to the paper sheet P, the toner images transferred onto the intermediate transfer belt 15.

In addition, the image forming apparatus 100 is provided with a fixing device 60 that fixes, onto the paper sheet P, the toner images transferred onto the paper sheet P.

Furthermore, the image forming apparatus 100 is provided with a control unit 40 that includes a CPU executing a program. The control unit 40 controls each unit in the image forming apparatus 100.

In addition, the image forming apparatus 100 is provided with a user interface (UI) 45 that is composed of a display panel or the like, that receives an instruction from a user, and that displays information with respect to the user.

Each of the image forming units 200 is provided with a developing device 14. In addition, each of the image forming units 200 is provided with a developer replenishment device 70 that replenishes the developing device 14 with a developer.

The developing device 14 visualizes an electrostatic latent image on the photoreceptor drum 11 with toner. In other words, the developing device 14 performs development with respect to the photoreceptor drum 11, which is an image holding body, to form, on the photoreceptor drum 11, an image formed by the toner.

The developer replenishment device 70 replenishes the developing device 14 with a developer. As described above, a developer is composed of a carrier and toner, and the developer replenishment device 70 replenishes the developing device 14 with a carrier and toner as a developer. Note that in the present exemplary embodiment, a carrier has a positive charging polarity, and toner has a negative charging polarity.

In each of the image forming units 200, the photoreceptor drum 11 rotates in a direction along an arrow A.

In addition, each of the image forming units 200 is provided with a charger 12 that charges the photoreceptor drum 11 and a laser exposure device 13 which is an example of an exposure device forming an electrostatic latent image on the photoreceptor drum 11. In FIG. 1, an exposure beam from the laser exposure device 13 is represented by a reference numeral “Bm”. Note that the exposure device may be composed of a device including a light source, such as an LED.

In addition, each of the image forming units 200 is provided with a primary transfer roll 16 that transfers a toner image formed on the photoreceptor drum 11 to the intermediate transfer belt 15 at the primary transfer unit 10. In addition, each of the image forming units 200 is provided with a drum cleaner 17 that removes a developer remaining on the photoreceptor drum 11.

A drive roll 31 driven by a motor (not shown) causes the intermediate transfer belt 15 to circulate and move at a predetermined speed in a direction along an arrow B which is shown in FIG. 1.

The primary transfer unit 10 is configured to include the primary transfer roll 16 that is disposed to face the photoreceptor drum 11 with the intermediate transfer belt 15 interposed therebetween. In addition, respective toner images on the photoreceptor drums 11 are electrostatically attracted onto the intermediate transfer belt 15 in order, so that superimposed toner images are formed on the intermediate transfer belt 15.

The secondary transfer unit 20 which is an example of a transfer unit is configured to include a secondary transfer roll 22 that is disposed on an outer surface side of the intermediate transfer belt 15. In addition, the secondary transfer unit 20 is configured to include a backup roll 25 that is disposed on an inner surface side of the intermediate transfer belt 15.

In the present exemplary embodiment, at the secondary transfer unit 20, toner images that are formed by the image forming units 200 and that are transferred to the intermediate transfer belt 15 are transferred to the paper sheet P transported to the secondary transfer unit 20.

Furthermore, in the present exemplary embodiment, an inversion mechanism 900 that inverts the paper sheet P is provided.

The inversion mechanism 900 inverts the paper sheet P with one surface on which the toner images have been transferred at the secondary transfer unit 20 upside down and supplies the paper sheet P again to the secondary transfer unit 20.

Accordingly, in the present exemplary embodiment, toner images can be formed on both surfaces of the paper sheet P.

Specifically, in the present exemplary embodiment, the inversion mechanism 900 inverts the paper sheet P upside down by feeding the paper sheet P, which has passed through the fixing device 60, to a branch path R2 branching off a paper sheet transport path R1. Specifically, after the paper sheet P passes through a branching portion BP, the inversion mechanism 900 transports the paper sheet P in a reverse direction and feeds the paper sheet P to the branch path R2.

The branch path R2 joins the paper sheet transport path R1 at a position upstream of the secondary transfer unit 20. Accordingly, in the present exemplary embodiment, the paper sheet P inverted upside down is supplied again to the secondary transfer unit 20. In this case, toner images are formed not only on the one surface of the paper sheet P but also on the other surface of the paper sheet P, so that the toner images are formed on both surfaces of the paper sheet P.

The flow of processing performed in the image forming apparatus 100 will be described.

The image forming apparatus 100 receives image data output from, for example, an image reading apparatus (not shown) or a computer. Then, the image data is subjected to image processing. Accordingly, image data corresponding to each of the plurality of image forming units 200 is generated.

Specifically, for example, image data used for image formation in which the developers of the basic colors, which are yellow, magenta, cyan, and black, are used and image data used for image formation in which the developer of a color other than the basic colors is used are generated. The generated image data is output to the laser exposure devices 13 provided at the image forming units 200.

In accordance with the image data input to the laser exposure devices 13, the laser exposure devices 13 irradiate the photoreceptor drums 11 with the exposure beams Bm emitted from, for example, semiconductor lasers.

In the present exemplary embodiment, after respective surfaces of the photoreceptor drums 11 are charged by the chargers 12, the surfaces are scanned and exposed to light by the laser exposure devices 13. Accordingly, electrostatic latent images are formed on the surfaces of the photoreceptor drums 11.

Next, development processing is performed by the developing devices 14 so that toner images are formed on the photoreceptor drums 11. The toner images are transferred onto the intermediate transfer belt 15 at the primary transfer units 10.

After the toner images are transferred onto the intermediate transfer belt 15, the toner images are moved to the secondary transfer unit 20 as the intermediate transfer belt 15 moves. In addition, at this time, the paper sheet P from a first paper sheet accommodation portion 53 or a second paper sheet accommodation portion 54 is transported to the secondary transfer unit 20 by transport rolls 52 or the like.

Then, the toner images on the intermediate transfer belt 15 are electrostatically transferred onto the paper sheet P in a collective manner at the secondary transfer unit 20.

Thereafter, the paper sheet P onto which the toner images have been transferred is separated from the intermediate transfer belt 15 and is transported to a transport belt 55. The transport belt 55 transports the paper sheet P to the fixing device 60.

The paper sheet P transported to the fixing device 60 is heated and pressed by the fixing device 60. Accordingly, the toner images on the paper sheet P are fixed to the paper sheet P. Then, the paper sheet P is discharged from the image forming apparatus 100.

Note that in a case where toner images are to be formed on both surfaces of the paper sheet P, the paper sheet P is supplied again to the secondary transfer unit 20 through the branch path R2 after the paper sheet P passes through the fixing device 60.

Then, toner images are transferred to the other surface of the paper sheet P at the secondary transfer unit 20. Thereafter, the paper sheet P passes through the fixing device 60 again and the toner images transferred to the other surface are fixed to the paper sheet P.

The developing devices 14 will be described.

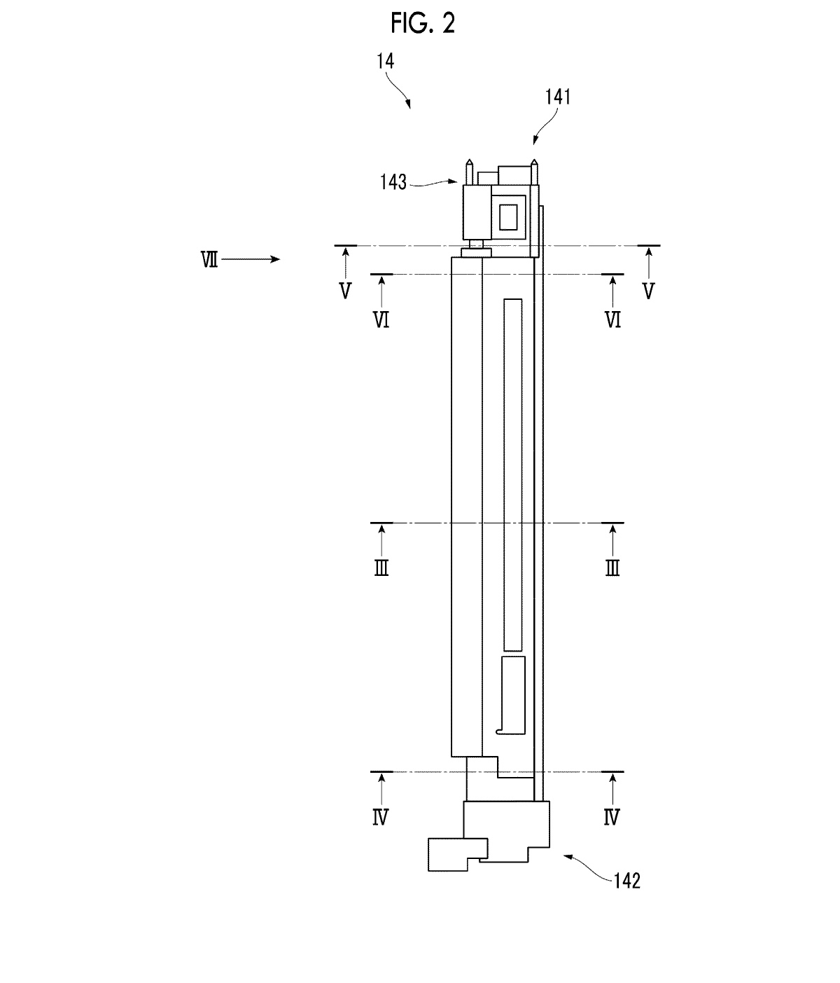

FIG. 2 is a view showing the developing device 14 as seen from above.

In a case where the developing device 14 is installed in the image forming apparatus 100, the developing device 14 is disposed along a depth direction of the image forming apparatus 100. The developing device 14 includes one end portion 141 and the other end portion 142, of which the positions are different from each other in a longitudinal direction.

In a case where the developing device 14 is installed in the image forming apparatus 100, the developing device 14 is installed in the image forming apparatus 100 such that the one end portion 141 is positioned on a rear side of the image forming apparatus 100 and the other end portion 142 is positioned on a front side of the image forming apparatus 100.

A drive force receiving portion 143 that receives a drive force is provided at the one end portion 141 of the developing device 14.

In the present exemplary embodiment, a drive force from a drive source (not shown), such as a motor, is transmitted to the drive force receiving portion 143, the drive source being provided on a body side of the image forming apparatus 100.

The drive force receiving portion 143 is linked to a transport member or the like (which will be described later) provided inside the developing device 14. In the present exemplary embodiment, the transport member or the like is rotated as the drive force from the drive source is transmitted to the drive force receiving portion 143.

In the present exemplary embodiment, as will be described later, four members, which are a one-direction transport member, an opposite-direction transport member, a facing member, and a lower-side transport member, are provided as members that rotate as the drive force is received from the drive source. The drive force receiving portion 143 may be provided to correspond to each of the four members. In addition, a drive force from the drive source may be transmitted to each of four drive force receiving portions 143.

In addition, alternatively, drive force receiving portions 143 of which the number is smaller than the number of the four members, for example, one drive force receiving portion 143, may be provided. In addition, a drive force transmitted from the drive source to the drive force receiving portion 143 may be transmitted to each of the four members through a transmission mechanism (not shown) provided at the developing device 14.

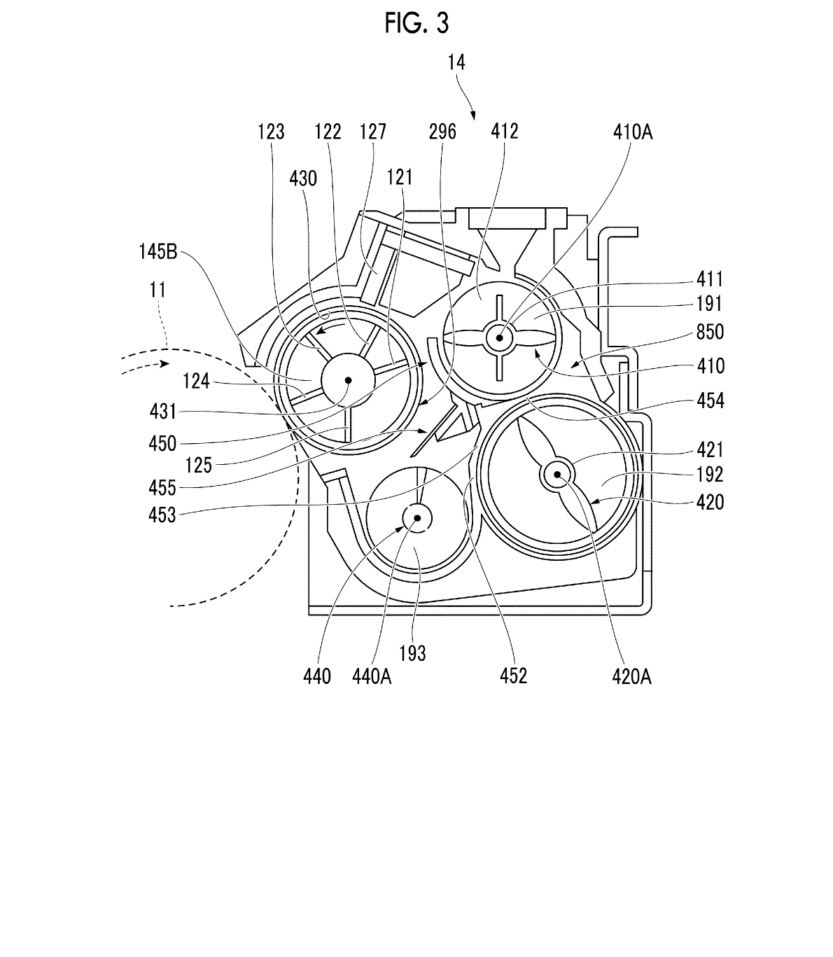

FIG. 3 is a cross-sectional view of the developing device 14 taken along line III-III in FIG. 2. FIG. 3 shows the state of a cross section of a central portion of the developing device 14 in the longitudinal direction.

The developing device 14 is provided with a one-direction movement path 191 through which a developer passes in a case where the developer is to be moved in one direction.

In addition, the developing device 14 is provided with an opposite-direction movement path 192 through which the developer passes in a case where the developer is to be moved in a direction opposite to the one direction. The opposite-direction movement path 192 is disposed below the one-direction movement path 191.

In the one-direction movement path 191, the developer moves in a direction perpendicular to the paper surface of FIG. 3 and in a direction to the rear side of the paper surface. In addition, in the opposite-direction movement path 192, the developer moves in a direction perpendicular to the paper surface of FIG. 3 and in a direction to the front side of the paper surface.

The one-direction movement path 191 is provided with a one-direction transport member 410 that transports the developer. In the present exemplary embodiment, the developer moves in the direction to the rear side as the one-direction transport member 410 rotates around a rotary shaft 411 that extends along the one-direction movement path 191.

More specifically, in the present exemplary embodiment, the developer moves in the direction to the rear side as the one-direction transport member 410 receives a drive force transmitted from the above-described drive force receiving portion 143 (refer to FIG. 2) and the one-direction transport member 410 rotates.

In the present exemplary embodiment, the one-direction transport member 410 transports the developer in the direction to the rear side, which is the one direction. The one-direction transport member 410 is a rotating member that rotates around an axis 410A extending along the one direction.

The opposite-direction movement path 192 is provided with an opposite-direction transport member 420 that transports the developer. The opposite-direction transport member 420 is disposed below the one-direction transport member 410.

In the present exemplary embodiment, the developer moves in the direction to the front side as the opposite-direction transport member 420 rotates around a rotary shaft 421 that extends along the opposite-direction movement path 192.

More specifically, the developer moves in the direction to the front side as the opposite-direction transport member 420 receives a drive force transmitted from the above-described drive force receiving portion 143 and the opposite-direction transport member 420 rotates.

In the present exemplary embodiment, the opposite-direction transport member 420 transports the developer in the direction opposite to the one direction.

A facing member 430 that is disposed at a position facing the photoreceptor drum 11 is provided to the left of the one-direction transport member 410.

The facing member 430 supplies, to the photoreceptor drum 11, a developer supplied from the one-direction transport member 410. The developer is supplied from the one-direction transport member 410 to the facing member 430 and the facing member 430 supplies the developer to the photoreceptor drum 11.

The facing member 430 is composed of a cylindrical body. The facing member 430 is formed of, for example, a metal such as SUS.

The facing member 430 receives a drive force transmitted from the drive force receiving portion 143 (refer to FIG. 2) and rotates in a counterclockwise direction in the drawing around an axis 431. Furthermore, the facing member 430 moves, to the photoreceptor drum 11, a developer that is supplied from the one-direction transport member 410 and that adheres to an outer peripheral surface of the facing member 430.

Accordingly, the developer is supplied to the photoreceptor drum 11, and toner contained in the developer adheres to a surface of the photoreceptor drum 11.

The facing member 430 is a rotating member that rotates around the axis 431 extending along the above-described one direction. In addition, the one-direction transport member 410 is also a rotating member that rotates around the axis 410A extending along the above-described one direction.

In the present exemplary embodiment, the facing member 430 and the one-direction transport member 410 are provided such that the axis 410A of the one-direction transport member 410 is positioned above the axis 431 of the facing member 430.

Furthermore, in the present exemplary embodiment, a first movement restriction portion 450 disposed between the facing member 430 and the one-direction transport member 410 is provided. The first movement restriction portion 450 restricts movement of a portion of a developer caused to move toward the facing member 430 from the one-direction transport member 410.

In the present exemplary embodiment, a portion of a developer on the one-direction movement path 191 that moves over the first movement restriction portion 450 is supplied to the facing member 430.

Furthermore, in the present exemplary embodiment, a lower-side transport member 440 that is disposed below the facing member 430 is provided. The lower-side transport member 440 is a rotating member that rotates around an axis 440A extending along the above-described one direction.

The lower-side transport member 440 is disposed closer to the photoreceptor drum 11 side than the opposite-direction transport member 420 is.

The lower-side transport member 440 and the opposite-direction transport member 420 are disposed along the above-described one direction and are disposed in a state where the positions thereof are offset from each other in a horizontal direction.

The lower-side transport member 440 transports a developer separated from the facing member 430 in the direction perpendicular to the paper surface of FIG. 3 and in the direction to the rear side of the paper surface.

The lower-side transport member 440 transports the developer separated from the facing member 430 in the above-described one direction, so that the developer is supplied to one end portion side of the opposite-direction transport member 420 (details will be described later).

The lower-side transport member 440 is rotated by a drive force transmitted from the drive force receiving portion 143 (refer to FIG. 2). The lower-side transport member 440 transports a developer separated from the facing member 430 in the direction perpendicular to the paper surface of FIG. 3 and in the direction to the rear side of the paper surface.

The lower-side transport member 440 is provided on a lower-side movement path 193 that is disposed closer to the photoreceptor drum 11 side than the opposite-direction movement path 192 is.

The lower-side movement path 193 is disposed to extend in the direction perpendicular to the paper surface of FIG. 3 and is disposed below the facing member 430. In the present exemplary embodiment, the developer separated from the facing member 430 moves along the lower-side movement path 193.

Furthermore, in the present exemplary embodiment, a second movement restriction portion 452 disposed between the lower-side transport member 440 and the opposite-direction transport member 420 is provided. The second movement restriction portion 452 restricts movement of a portion of a developer moving toward the lower-side transport member 440 from the opposite-direction transport member 420.

In addition, in the present exemplary embodiment, a third movement restriction portion 453 disposed between the facing member 430 and the opposite-direction transport member 420 is provided. The third movement restriction portion 453 restricts movement of a developer moving toward the facing member 430 from the opposite-direction transport member 420.

Furthermore, in the present exemplary embodiment, a fourth movement restriction portion 454 is provided between the one-direction transport member 410 and the opposite-direction transport member 420.

The fourth movement restriction portion 454 restricts movement of a developer moving from the one-direction transport member 410 to the opposite-direction transport member 420. In addition, the fourth movement restriction portion 454 restricts movement of a developer moving from the opposite-direction transport member 420 to the one-direction transport member 410.

In the present exemplary embodiment, the second to fourth movement restriction portions 452 to 454 are integrated with each other. The second to fourth movement restriction portions 452 to 454 are configured by means of one common component.

Furthermore, in the present exemplary embodiment, a fifth movement restriction portion 455 that is disposed between the facing member 430 and the lower-side transport member 440 and that restricts movement of a developer moving toward the facing member 430 from the lower-side transport member 440 is provided.

Furthermore, in the present exemplary embodiment, a magnet roll 145B is provided inside the facing member 430.

The magnet roll 145B is provided with five magnetic poles 121 to 125 arranged in a circumferential direction of the magnet roll 145B.

The magnetic pole 121 is a pickup pole and attracts a developer supplied from the one-direction movement path 191. Accordingly, the developer adheres to a surface of the facing member 430.

The magnetic poles 122 to 124 have a role as transport poles and move the developer on the surface of the facing member 430 to a downstream side in a rotation direction of the facing member 430.

In the rotation direction of the facing member 430, a facing restriction portion 127 is provided downstream of the magnetic pole 122 and upstream of the magnetic pole 123. In addition, the facing restriction portion 127 is disposed at a position facing the outer peripheral surface of the facing member 430.

The facing restriction portion 127 is disposed with a gap provided between the facing restriction portion 127 and the facing member 430.

The facing restriction portion 127 restricts movement of a portion of a developer adhering to the surface of the facing member 430, so that the thickness of the developer adhering to the surface of the facing member 430 becomes a predetermined thickness.

In other words, the facing restriction portion 127 restricts movement of a portion of a developer that adheres to the outer peripheral surface of the facing member 430 and that moves toward the photoreceptor drum 11 as the facing member 430 rotates.

In a case where the developer on the surface of the facing member 430 moves to the downstream side in the rotation direction of the facing member 430, the developer moves to the surface of the photoreceptor drum 11. Toner contained in the developer adheres to the photoreceptor drum 11.

Accordingly, development is performed, and an image consisting of the toner is formed on the surface of the photoreceptor drum 11.

The image is temporarily held by the photoreceptor drum 11 and is moved to the primary transfer unit 10 (refer to FIG. 1) with the photoreceptor drum 11 rotating. Then, the image is transferred to the intermediate transfer belt 15.

The magnetic pole 125 has a role as a pick-off pole, forms a repulsive magnetic field, and causes the developer adhering to the surface of the facing member 430 to be separated from the facing member 430. The magnetic pole 125 causes the developer that remains on the surface of the facing member 430 without being transferred to the photoreceptor drum 11 to be separated from the facing member 430.

In the present exemplary embodiment, separation of the developer occurs at a separation position 296.

In the present exemplary embodiment, the separation position 296 is positioned ahead of the magnetic pole 121 having a role as a pickup pole. In the present exemplary embodiment, the developer is separated ahead of the magnetic pole 121.

The developer separated from the facing member 430 moves downward and reaches the lower-side movement path 193.

The developer that has reached the lower-side movement path 193 is moved toward the one end portion 141 (refer to FIG. 2) side of the developing device 14 by the lower-side transport member 440. Then, the developer is moved to the opposite-direction movement path 192 (refer to FIG. 3).

The one-direction transport member 410 (refer to FIG. 3), the opposite-direction transport member 420, the facing member 430, the magnet roll 145B, and the lower-side transport member 440 are disposed to extend in the direction perpendicular to the paper surface of FIG. 3 and to be parallel to each other.

The one-direction transport member 410 includes the rotary shaft 411 that extends along the longitudinal direction of the developing device 14 and a protruding portion 412 that protrudes from an outer peripheral surface of the rotary shaft 411.

The protruding portion 412 is provided over an area extending from one end portion to the other end portion of the rotary shaft 411 in an axial direction and is provided in a spiral shape. In other words, the protruding portion 412 is provided in a screw-like shape.

In the present exemplary embodiment, in a case where the rotary shaft 411 provided at the one-direction transport member 410 rotates, the protruding portion 412 presses a developer in the axial direction of the rotary shaft 411 and thus the developer moves in a direction in which the rotary shaft 411 extends.

Note that the opposite-direction transport member 420 and the lower-side transport member 440 have the same configuration as the one-direction transport member 410, and the opposite-direction transport member 420 and the lower-side transport member 440 are also provided with a rotary shaft extending along the longitudinal direction of the developing device 14 and a protruding portion having a spiral shape.

The one-direction transport member 410, the opposite-direction transport member 420, the facing member 430, and the lower-side transport member 440 are rotating members that rotate around axes extending along the above-described one direction.

In the present exemplary embodiment, an axis 420A of the opposite-direction transport member 420 is positioned to be farther from the facing member 430 than the axis 410A of the one-direction transport member 410 is in a case where the positions of the axes in the horizontal direction are compared with each other.

In addition, in the present exemplary embodiment, the axis 420A of the opposite-direction transport member 420 is positioned at a position offset from a position directly below the axis 410A of the one-direction transport member 410.

In addition, in the present exemplary embodiment, the axis 440A of the lower-side transport member 440 is positioned at a position offset from a position directly below the axis 431 of the facing member 430.

More specifically, in the present exemplary embodiment, the axis 440A of the lower-side transport member 440 is positioned to be closer to the opposite-direction transport member 420 than the axis 431 of the facing member 430 is in a case where the positions of the axes in the horizontal direction are compared with each other.

Furthermore, in the present exemplary embodiment, the axis 440A of the lower-side transport member 440 is positioned below the axis 420A of the opposite-direction transport member 420 in a case where the positions of the axes in a perpendicular direction are compared with each other.

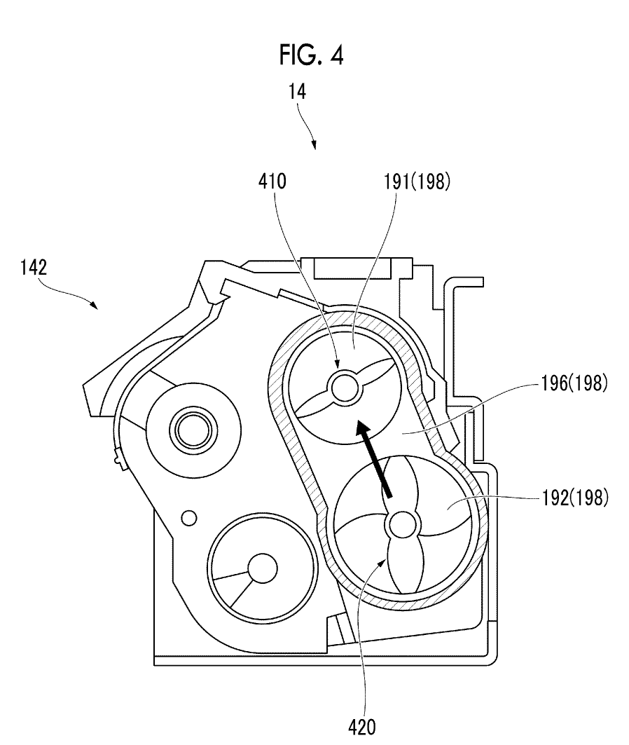

FIG. 4 is a cross-sectional view of the developing device 14 taken along line IV-IV in FIG. 2.

FIG. 4 shows the state of a cross section of the other end portion 142 of the developing device 14.

In the present exemplary embodiment, as shown in FIG. 4, an upward movement path 196 disposed along the vertical direction is provided at the other end portion 142 of the developing device 14.

In the present exemplary embodiment, a developer that has moved through the opposite-direction movement path 192 moves toward the one-direction movement path 191 through the upward movement path 196.

The developing device 14 of the present exemplary embodiment has a configuration in which the upward movement path 196 which is an example of a second movement path, through which a developer moving from the opposite-direction transport member 420 to the one-direction transport member 410 passes, is provided.

Here, the expression “being disposed along the vertical direction” means not only a state where the upward movement path 196 is disposed along the perpendicular direction but also a state where the upward movement path 196 is disposed in a state of being inclined with respect to the perpendicular direction.

In the present exemplary embodiment, in a case where a developer is transported to the other end portion 142 of the developing device 14 by the opposite-direction transport member 420, the developer accumulates at a lower portion of the upward movement path 196. The developer gradually moves upward in the upward movement path 196 after the accumulation.

Accordingly, the developer is supplied to the one-direction transport member 410. The one-direction transport member 410 transports, toward the one end portion 141 (refer to FIG. 2) of the developing device 14 along the one-direction movement path 191, a developer that has moved through the upward movement path 196.

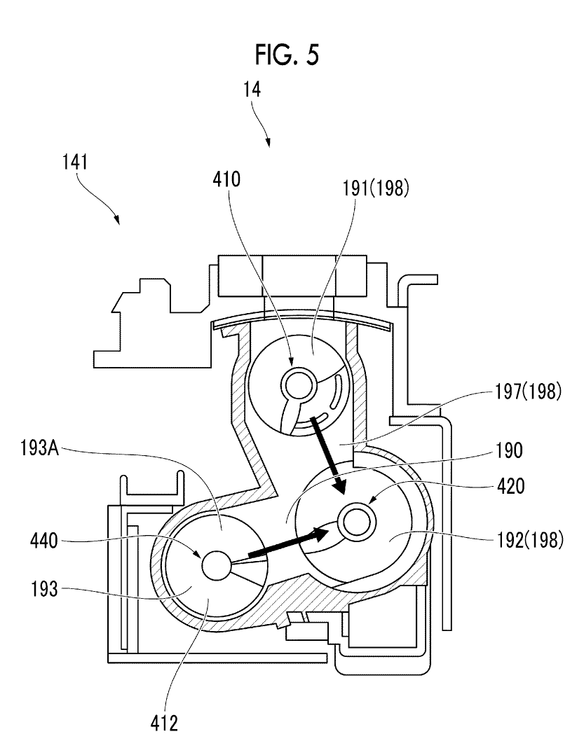

FIG. 5 is a cross-sectional view of the developing device 14 taken along line V-V in FIG. 2.

In the present exemplary embodiment, as shown in FIG. 5, a downward movement path 197 disposed along the vertical direction is provided at the one end portion 141 of the developing device 14.

Here, the expression “being disposed along the vertical direction” means not only a state where the downward movement path 197 is disposed along the perpendicular direction but also a state where the downward movement path 197 is disposed in a state of being inclined with respect to the perpendicular direction.

In the present exemplary embodiment, a developer that has moved through the one-direction movement path 191 moves toward the opposite-direction movement path 192 through the downward movement path 197.

In the present exemplary embodiment, the downward movement path 197 which is an example of a first movement path, through which a developer moving from the one-direction transport member 410 to the opposite-direction transport member 420 passes, is provided.

In the present exemplary embodiment, a developer that has moved through the one-direction movement path 191 moves toward the opposite-direction movement path 192 through the downward movement path 197. Next, the developer moves toward the other end portion 142 (refer to FIG. 2) of the developing device 14 through the opposite-direction movement path 192.

In the developing device 14 of the present exemplary embodiment, a developer movement path 198 that is formed in an annular shape by four paths, which are the one-direction movement path 191, the downward movement path 197, the opposite-direction movement path 192, and the upward movement path 196 (refer to FIG. 4), is provided.

In the present exemplary embodiment, a developer circulates and moves along the annular developer movement path 198.

Furthermore, in the present exemplary embodiment, as shown in FIG. 5, a connection path 190 that extends in a lateral direction and that connects the lower-side movement path 193 and the opposite-direction movement path 192 to each other is provided.

In the present exemplary embodiment, the connection path 190 which is an example of a movement path for a developer moving from the lower-side transport member 440 to the opposite-direction transport member 420 is provided.

The connection path 190 is disposed in a state of being inclined to extend obliquely upward. In other words, the connection path 190 is disposed in a state of being inclined with respect to both the horizontal direction and the perpendicular direction.

In the present exemplary embodiment, a developer that has been moved along the lower-side movement path 193 by the lower-side transport member 440 moves to the opposite-direction movement path 192 through the connection path 190.

In the present exemplary embodiment, a developer accumulating at an end portion of the lower-side movement path 193 that is positioned on a downstream side in a developer movement direction is pressed by a developer sequentially transported from an upstream side. The pressed developer moves to the opposite-direction movement path 192 through the connection path 190.

In the developing device 14 of the present exemplary embodiment, as described above, the annular developer movement path 198 is provided. A developer is agitated as the developer moves through the annular developer movement path 198.

Furthermore, in the present exemplary embodiment, while a developer to be agitated is passing through the one-direction movement path 191 (refer to FIG. 3), the developer is partially supplied to the facing member 430 over the first movement restriction portion 450 and the developer adheres to the surface of the facing member 430.

As the facing member 430 rotates, the developer adhering to the surface of the facing member 430 is moved to a position facing the photoreceptor drum 11 and thus the developer is supplied to the photoreceptor drum 11.

A portion of the developer that adheres to the surface of the facing member 430 and that is not supplied to the photoreceptor drum 11 passes through a position facing the magnetic pole 125 (refer to FIG. 3) having a role as a pick-off pole. In a case where the developer reaches the separation position 296, the developer is separated from the facing member 430 and moves downward.

The developer moving downward reaches the lower-side movement path 193 provided with the lower-side transport member 440.

The developer that has reached the lower-side movement path 193 moves through the lower-side movement path 193 to reach an end portion 193A of the lower-side movement path 193 that is positioned on the downstream side in the developer movement direction.

Thereafter, the developer moves to the opposite-direction movement path 192 through the connection path 190 by being pressed by a developer sequentially transported from the upstream side.

In a case where the developer moves to the opposite-direction movement path 192, the developer moves along the annular developer movement path 198 again.

The developing device 14 will be further described.

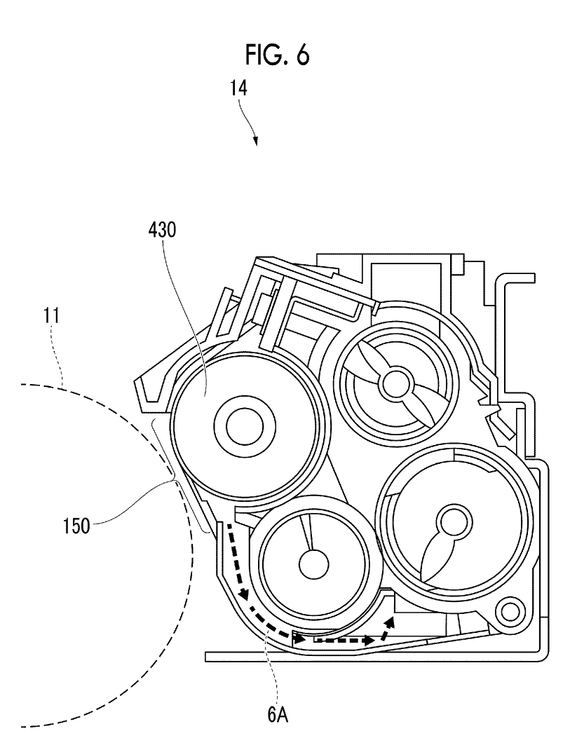

FIG. 6 is an explanatory view for description of a developer suction mechanism in the developing device 14. FIG. 6 shows a cross section of the developing device 14 taken along line VI-VI of FIG. 2.

In the present exemplary embodiment, as shown in FIG. 6, the developing device 14 is provided with an opening portion 150 facing the photoreceptor drum 11.

In the present exemplary embodiment, the facing member 430 is partially exposed through the opening portion 150.

In the present exemplary embodiment, the opening portion 150 is positioned between the photoreceptor drum 11 and a central portion of the facing member 430 in a radial direction.

The facing member 430 supplies a developer to the photoreceptor drum 11. The facing member 430 can also be regarded as a supply member.

The opening portion 150 is provided to extend in the longitudinal direction of the developing device 14. The opening portion 150 is provided to extend along an axial direction of the facing member 430.

The opening portion 150 is an example of an opening that is disposed in a state of facing an image holding body side.

In the image forming apparatus 100 of the present exemplary embodiment, a suction unit that sucks air is provided on a body side of the image forming apparatus 100.

In the present exemplary embodiment, suction performed by the suction unit causes air to flow in the developing device 14 as represented by arrows 6A in FIG. 6. Accordingly, a developer floating around the developing device 14 is moved to the suction unit.

In FIG. 6, the developing device 14 is disposed such that the opening portion 150 faces the photoreceptor drum 11 side.

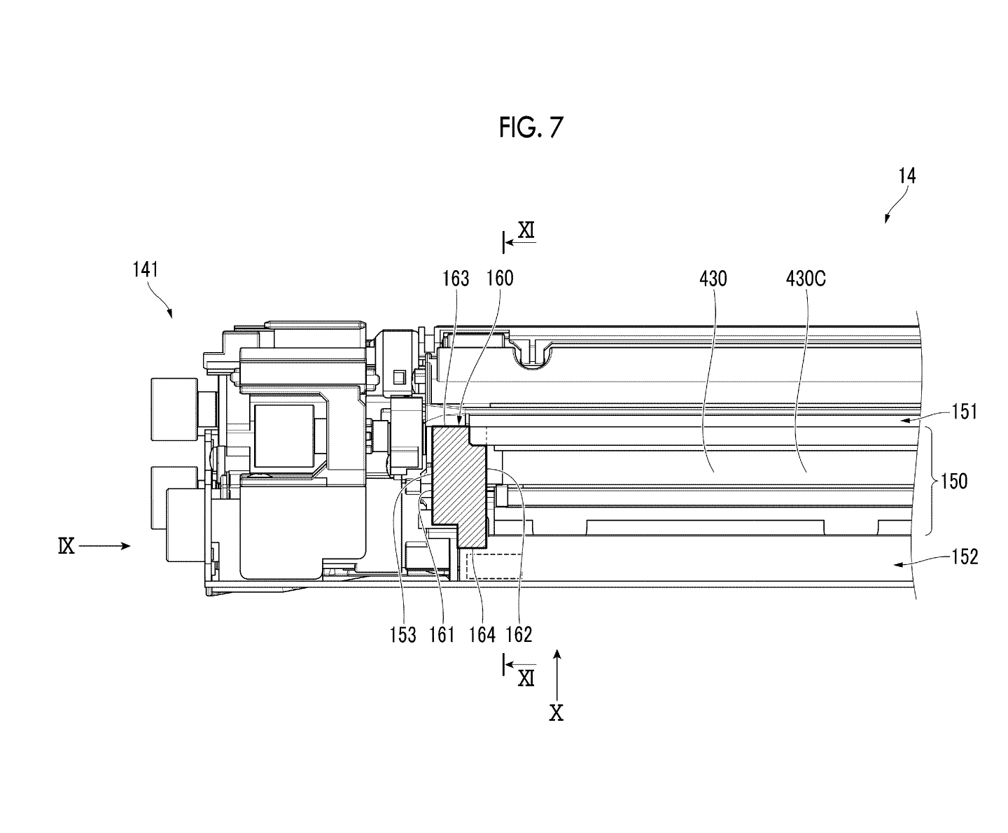

FIG. 7 is a view showing how the one end portion 141 of the developing device 14 is in a case where the one end portion 141 is seen in a direction represented by an arrow VII in FIG. 2. FIG. 7 shows the developing device 14 as seen from the opening portion 150 side.

The opening portion 150 of the developing device 14 is provided with an opening upper portion 151 that forms an upper edge of the opening portion 150 and an opening lower portion 152 that forms a lower edge of the opening portion 150.

In addition, the opening portion 150 is provided with an opening left portion 153 that forms a left edge of the opening portion 150 and an opening right portion that forms a right edge of the opening portion 150. The opening right portion is not shown.

A portion of the outer peripheral surface of the facing member 430, which is exposed through the opening portion 150, is positioned between the opening upper portion 151 and the opening lower portion 152.

Furthermore, in the present exemplary embodiment, a blocking member 160 that partially blocks the opening portion 150 is provided. The blocking member 160 restricts movement of a developer.

In the present exemplary embodiment, a developer moves toward the photoreceptor drum 11 side shown in FIG. 1 from the facing member 430 side.

The blocking member 160 restricts movement of the developer moving toward the photoreceptor drum 11 side from the facing member 430 side. The blocking member 160 can also be regarded as a restriction member that restricts movement of a developer. In addition, the blocking member 160 can also be regarded as an end portion seal or a toner prevention member.

In the case of the developing device 14, air is taken into the developing device 14 in a case where a developer adhering to the outer peripheral surface of the facing member 430 returns to the developing device 14. Accordingly, the internal pressure of the developing device 14 increases.

Due to the increase in internal pressure, the developer in the developing device 14 is caused to move to the outside of the developing device 14 through the opening portion 150. In this case, the developer moves toward the photoreceptor drum 11 side from the facing member 430 side.

The blocking member 160 restricts movement of the above-described developer moving toward the photoreceptor drum 11 side from the facing member 430 side.

The blocking member 160 is provided in a plate-like shape. The plate-shaped blocking member 160 is provided along the axial direction of the facing member 430. In addition, the plate-shaped blocking member 160 is provided along a circumferential direction of the facing member 430.

The blocking member 160 is formed of, for example, a resin material. Examples of the resin material include polyethylene terephthalate and polyurethane.

The blocking member 160 includes a left end portion 161 and a right end portion 162 which are at different positions in the axial direction of the facing member 430.

The right end portion 162 of the blocking member 160 is positioned closer to a central portion 430C side of the facing member 430 in the axial direction than the left end portion 161 is.

The right end portion 162 of the blocking member 160 can be understood as an end portion on a central side, which is an end portion positioned on the central portion 430C side of the facing member 430 in the axial direction.

The left end portion 161 of the blocking member 160 is positioned on a side opposite to the right end portion 162 which is the central-portion-side end portion.

The left end portion 161 can be regarded as an opposite-side end portion positioned on a side opposite to the right end portion 162.

In addition, the blocking member 160 includes an upper end portion 163 that is positioned on an upstream side in the rotation direction of the facing member 430. In addition, the blocking member 160 includes a lower end portion 164 that is positioned on the downstream side in the rotation direction of the facing member 430.

The blocking member 160 is disposed at a position facing an end portion of the facing member 430 in the axial direction.

The upper end portion 163 of the blocking member 160 is affixed to, for example, a bearing member provided at an end portion of the facing member 430. The bearing member is a member that supports the facing member 430 in a rotatable state.

The upper end portion 163 of the blocking member 160 may be affixed to a member other than the bearing member, such as a housing.

In addition, the lower end portion 164 of the blocking member 160 is affixed to the opening lower portion 152.

The lower end portion 164 is affixed to a surface of the opening lower portion 152, that is, a surface on the photoreceptor drum 11 side. Note that the lower end portion 164 may be affixed to a rear surface of the opening lower portion 152, that is, a surface on the facing member 430 side.

The blocking member 160 is provided to cover a left side of the opening portion 150 in the drawing.

Although the description will not be provided, the blocking member 160 is also provided on a right side of the opening portion 150. The blocking member 160 is also provided at a position facing the other end portion 433 of the facing member 430.

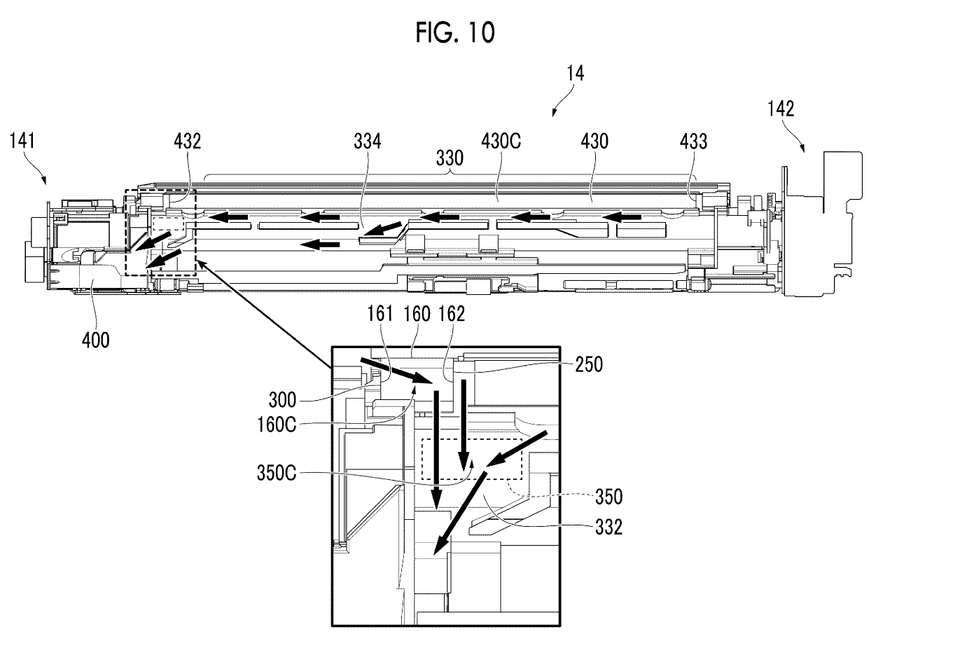

Note that the other end portion 433 of the facing member 430 is shown in FIG. 10.

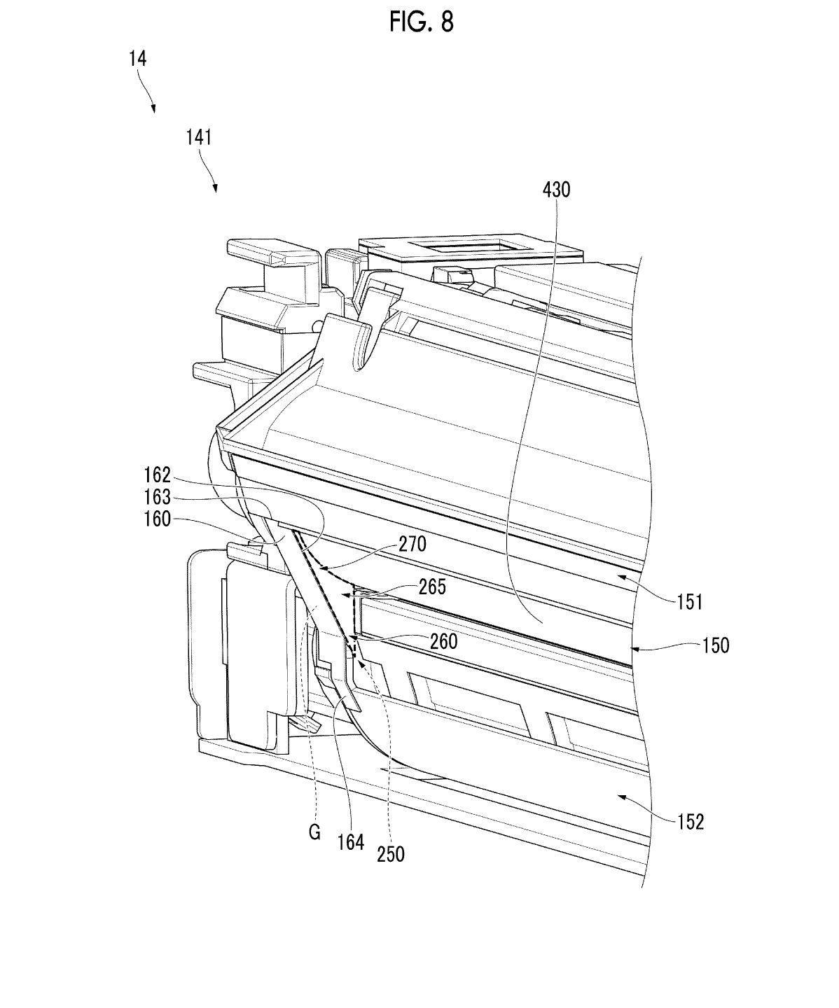

FIG. 8 is a perspective view showing the one end portion 141 side of the developing device 14 as seen from the other end portion 142 side of the developing device 14.

The blocking member 160 is disposed between the photoreceptor drum 11 shown in FIG. 6 and the facing member 430 disposed at a position facing the photoreceptor drum 11.

In the present exemplary embodiment, as described above, the upper end portion 163 of the blocking member 160 is affixed to the bearing member provided at the end portion of the facing member 430. In addition, the lower end portion 164 is affixed to the opening lower portion 152.

In the present exemplary embodiment, the blocking member 160 is disposed in a state where a gap G is provided between the blocking member 160 and a plurality of constituent members constituting the developing device 14.

The blocking member 160 is disposed in a state where the gap G is provided between the blocking member 160 and the facing member 430 which is an example of a constituent member.

In the present exemplary embodiment, the blocking member 160 and the facing member 430 are not in contact with each other. The gap G is provided between the blocking member 160 and the facing member 430.

A first opening 250 through which air outside the gap G can flow into the gap G is provided between the right end portion 162 of the blocking member 160 and the facing member 430.

The first opening 250 is provided to extend in the vertical direction. The first opening 250 has different widths in the vertical direction.

Specifically, the width of a portion 260 positioned below a central portion 265 of the first opening 250 in the vertical direction and the width of a portion 270 positioned above the central portion 265 are smaller than the width of the central portion 265 of the first opening 250.

The first opening 250 is formed such that the width of the first opening 250 increases from the portion 260 positioned below the central portion 265 toward the central portion 265. In addition, the first opening 250 is formed such that the width of the first opening 250 increases from the portion 270 positioned above the central portion 265 toward the central portion 265.

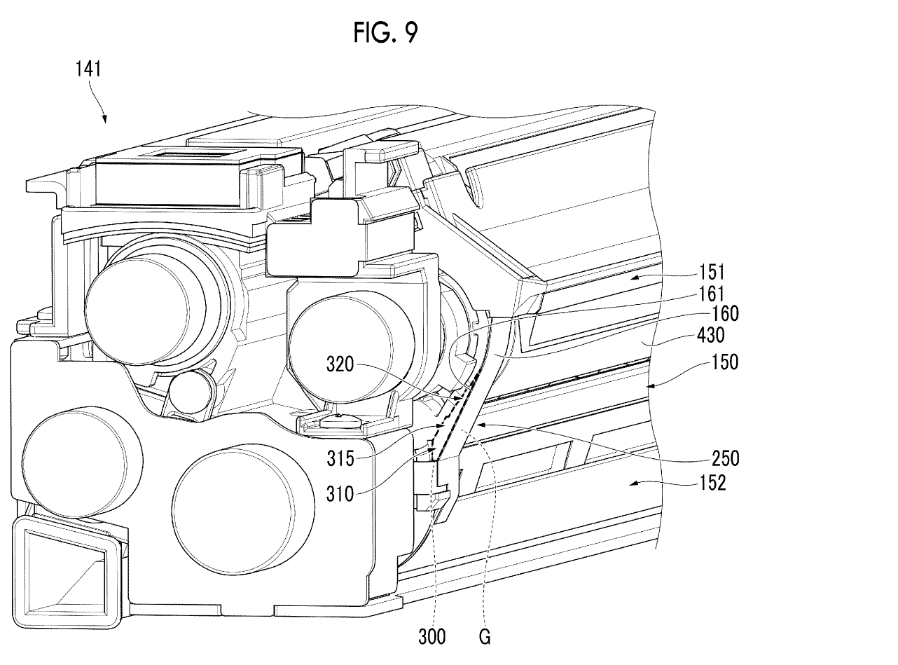

FIG. 9 is a perspective view showing the one end portion 141 of the developing device 14 as seen in a direction represented by an arrow IX in FIG. 7.

In the present exemplary embodiment, a second opening 300 is provided between the left end portion 161 of the blocking member 160 and the facing member 430. In the present exemplary embodiment, air outside the gap G flows into the gap G through the second opening 300.

In the present exemplary embodiment, as shown in FIG. 9, the second opening 300 is provided to extend in the vertical direction.

In addition, the second opening 300 is formed to have different widths in the vertical direction.

Specifically, the width of a portion 310 positioned below a central portion 315 of the second opening 300 in the vertical direction and the width of a portion 320 positioned above the central portion 315 are different from each other.

The width of the portion 310 of the second opening 300 that is positioned on a lower side in the vertical direction is larger than the width of the portion 320 that is positioned on an upper side.

Regarding the second opening 300, the width of the second opening 300 increases from the portion 320 positioned on the upper side toward the portion 310 positioned on the lower side.

FIG. 10 is a view of the developing device 14 as seen from below. FIG. 10 shows how the developing device 14 is in a case where the developing device 14 is seen in a direction represented by an arrow X in FIG. 7.

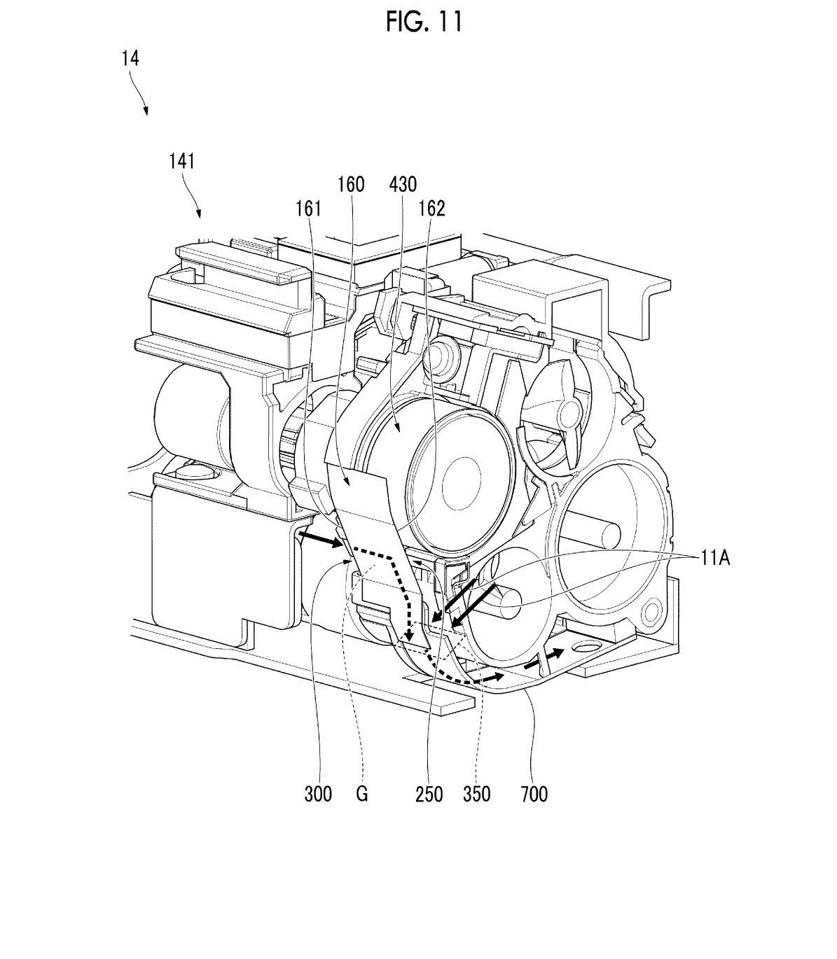

In addition, FIG. 11 is a perspective view of a cross section of the developing device 14 taken along line XI-XI of FIG. 7.

Note that in FIG. 10, a state where an exterior cover 700 provided at a lower portion of the developing device 14 is removed is shown in order to show how air flows in the developing device 14. In the present exemplary embodiment, as shown in FIG. 11, the exterior cover 700 is provided. FIG. 10 shows a state where the exterior cover 700 is removed.

In the present exemplary embodiment, as shown in FIG. 10, a discharge portion 400 through which air in the developing device 14 is discharged is provided on the one end portion 141 side of the developing device 14. The discharge portion 400 is a so-called duct and is composed of an annular member.

In the present exemplary embodiment, air in the developing device 14 moves, through the discharge portion 400, toward the suction unit (not shown) provided on the body side of the image forming apparatus 100.

As shown in FIG. 11, an inlet portion 350 that air moving toward the discharge portion 400 enters is provided on the one end portion 141 side of the developing device 14.

Furthermore, as shown in FIG. 10, a flow path 330 provided along the axial direction of the facing member 430 is provided.

A developer floating at a position facing the central portion 430C or the like of the facing member 430 moves toward the inlet portion 350 through the flow path 330.

Here, positions in the rotation direction of the facing member 430 will be compared with each other with reference to FIG. 11.

In the present exemplary embodiment, the position of the inlet portion 350 in the rotation direction is different from the positions of the first opening 250 and the second opening 300 in the rotation direction.

The inlet portion 350 is provided downstream of the first opening 250 and the second opening 300 in the rotation direction of the facing member 430.

In addition, positions in the axial direction of the facing member 430 will be compared with each other with reference to FIG. 10.

In the present exemplary embodiment, the position of the inlet portion 350 in the axial direction and the position of the second opening 300 in the axial direction are different from each other.

The inlet portion 350 is positioned closer to the central portion 430C side of the facing member 430 in the axial direction than a central portion 160C of the blocking member 160 is.

The inlet portion 350 includes a central portion 350C positioned at an intermediate position in a width direction.

The central portion 350C of the inlet portion 350 is positioned closer to the central portion 430C side of the facing member 430 in the axial direction than the central portion 160C of the blocking member 160 is.

The inlet portion 350 is provided in a state of being close to the central portion 430C side of the facing member 430 in the axial direction with respect to the blocking member 160. The central portion 350C is provided at a position at which the entire outer shape thereof can be visually recognized in FIG. 10 in which the developing device 14 as seen from below is shown.

Furthermore, the developing device 14 is provided with a connection flow path 332 that connects the discharge portion 400 and the inlet portion 350 to each other. The connection flow path 332 is provided to extend in the rotation direction of the facing member 430. In addition, the connection flow path 332 is provided to extend in the axial direction of the facing member 430.

The connection flow path 332 is provided to be inclined with respect to both the rotation direction and the axial direction of the facing member 430.

Air that has passed through the inlet portion 350 moves toward the discharge portion 400 through the connection flow path 332.

In a case where the connection flow path 332 is provided to be inclined, a stream of air flowing in an oblique downward direction as represented by arrows 11A in the drawing is likely to be generated outside the inlet portion 350 shown in FIG. 11.

In this case, air caused to move toward the inlet portion 350 is likely to pass through the installation position of the first opening 250, but is unlikely to pass through the second opening 300.

In a case where the second opening 300 is not provided and the second opening 300 is blocked in such a case, a developer is likely to accumulate at the installation position of the second opening 300. In this case, a developer is likely to be solidified at the installation position of the second opening 300.

In this case, the solidified developer falls to the inlet portion 350 or the connection flow path 332 positioned downstream of the inlet portion 350. Accordingly, an air flow path is narrowed. In a case where the air flow path is narrowed, it is difficult for air to be discharged from the developing device 14. In this case, a failure such as a development failure is likely to occur.

On the other hand, in the configuration of the present exemplary embodiment, a stream of air flowing toward the inlet portion 350 from the second opening 300 is generated. Accordingly, a developer is less likely to accumulate at the installation position of the second opening 300. In this case, the above-described failure is less likely to occur.

In the present exemplary embodiment, as described above, air in the developing device 14 moves toward the discharge portion 400.

In this case, a portion of the air enters the gap G through the first opening 250 shown in FIG. 11. Then, the air moves toward the inlet portion 350.

Furthermore, air enters the gap G through the second opening 300. Then, the air also moves toward the inlet portion 350.

As described above, in the present exemplary embodiment, air is supplied to the gap G formed between the blocking member 160 and the facing member 430 in a plurality of directions. In the present exemplary embodiment, air can be supplied to the inside of the gap G from the outside of the gap G in a plurality of directions.

In the present exemplary embodiment, air is supplied to the gap G from the right end portion 162 side of the blocking member 160. In addition, in the present exemplary embodiment, air is supplied to the gap G from the left end portion 161 side of the blocking member 160.

In the present exemplary embodiment, air can be supplied to the gap G from both the first opening 250 side and the second opening 300 side.

Note that in the present exemplary embodiment, as shown in FIG. 10, a flow path 334 through which air moving toward the discharge portion 400 passes is provided separately from the flow path 330 and the connection flow path 332. A portion of air moving toward the discharge portion 400 from a right side in the axial direction of the facing member 430 moves toward the discharge portion 400 through the flow path 334.

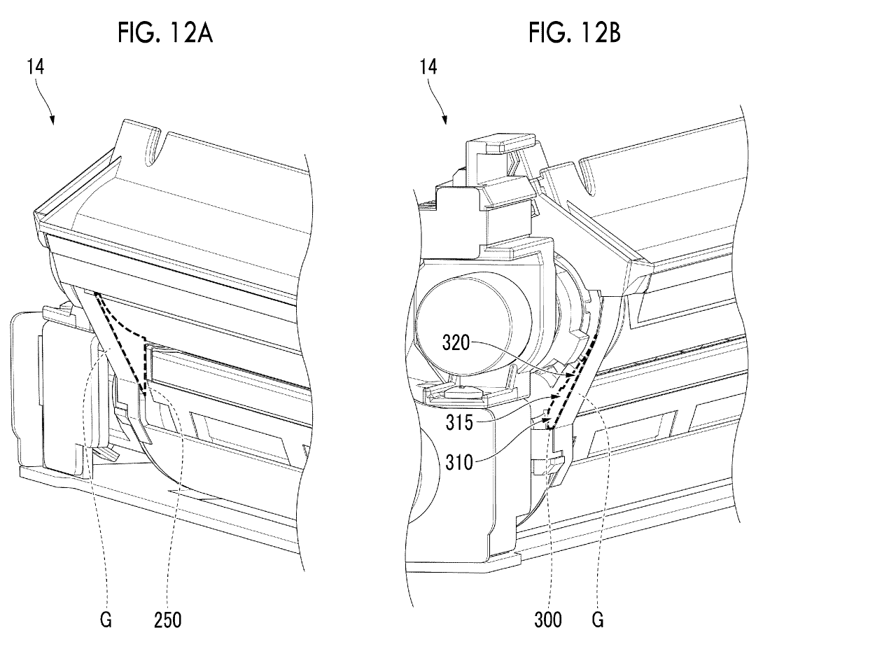

FIGS. 12A and 12B are views for comparison between the size of the first opening 250 and the size of the second opening 300. FIG. 12A is a view showing the first opening 250, and FIG. 12B is a view showing the second opening 300.

In the present exemplary embodiment, the sizes of the first opening 250 and the second opening 300 are different from each other.

In the present exemplary embodiment, the area of the second opening 300 is smaller than the area of the first opening 250.

Accordingly, a developer in the gap G is restrained from moving to the outside of the gap G through the second opening 300.

In the present exemplary embodiment, as represented by the arrows 11A in FIG. 11, generally, air enters the gap G from the first opening 250 side.

In this case, a portion of the air entering the gap G from the first opening 250 side may move to the outside of the gap G through the second opening 300. In this case, a developer in the gap G is likely to move to the outside of the gap G through the second opening 300.

However, in the present exemplary embodiment, as described above, the area of the second opening 300 is smaller than the area of the first opening 250. In this case, a developer in the gap G is less likely to move to the outside of the gap G through the second opening 300 in comparison with a case where the area of the second opening 300 is larger than the area of the first opening 250.

Furthermore, in the present exemplary embodiment, as described above and shown in FIG. 12B, the width of the portion 310 of the second opening 300 that is positioned on the lower side is larger than the width of the portion 320 of the second opening 300 that is positioned on the upper side.

In this case, the amount of air supplied to the lower side, on which the developer is likely to accumulate, is increased and thus accumulation of the developer is suppressed.

In the second opening 300, a developer is likely to accumulate at the portion 310 of the second opening 300 that is positioned on the lower side. In the present exemplary embodiment, for example, air favorably flows at a position where such accumulation is likely to occur and a developer is less likely to accumulate at the position where such accumulation is likely to occur.

Here, the developing device 14 according to the present exemplary embodiment will be further described.

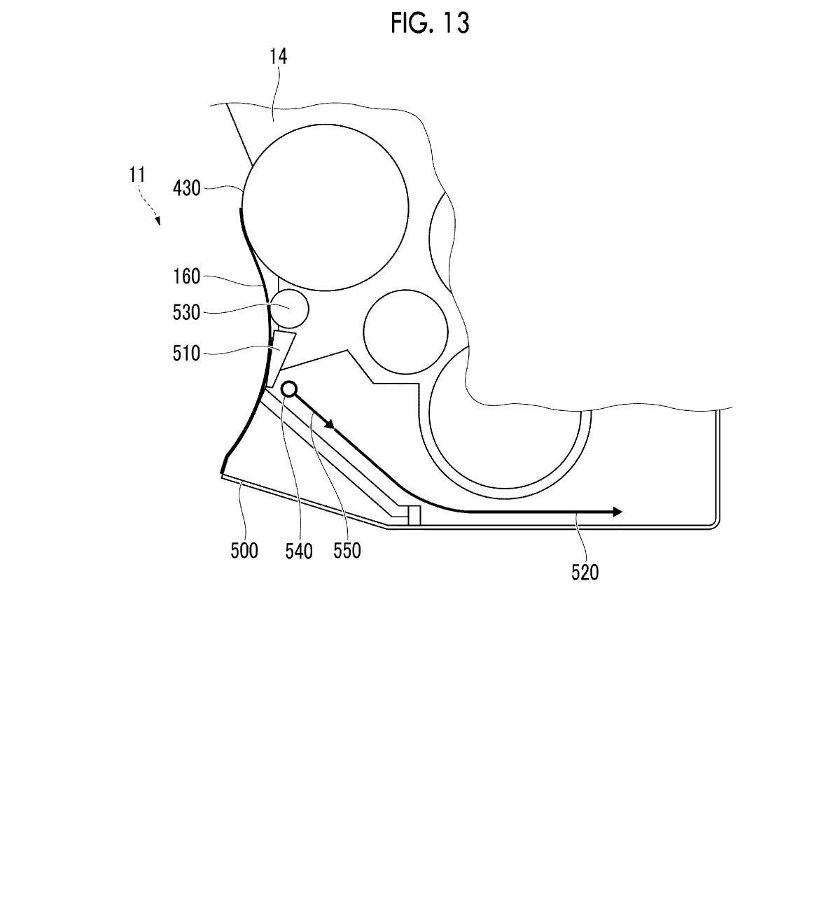

FIG. 13 is an explanatory view for description of a discharge mechanism that discharges air containing a developer in the developing device 14. More specifically, air collected by the discharge mechanism shown in FIG. 13 merges with air sucked by the suction mechanism shown in FIG. 6. Then, the air after confluence moves toward the suction unit (not shown) through the duct-shaped discharge portion 400 (refer to FIG. 10), as described above.

As shown in FIG. 13, the developing device 14 includes a side wall portion 500 that is on the other end portion 142 side in a case where the developing device 14 is seen from the other end portion 142 side (refer to FIG. 2). The viewing direction in FIG. 13 is the same as the viewing direction in the case of FIG. 3.

The side wall portion 500 holds the above-described facing member 430.

As shown in FIG. 13, the side wall portion 500 includes an opening portion 510. A surface of the opening portion 510 has a shape that extends in a direction intersecting the surface of the above-described opening portion 150 (refer to FIG. 6) facing the photoreceptor drum 11. Intersection between the surfaces mentioned herein means intersection between a virtual plane obtained in a case where a surface indicating the opening region of the opening portion 150 is extended and the surface of the opening portion 510 or a virtual plane that is obtained in a case where the surface of the opening portion 510 is extended.

The opening portion 510 is an example of another opening.

The opening portion 510 is positioned closer to the photoreceptor drum 11 than the lower-side transport member 440 is. In addition, the opening portion 510 is positioned below the facing member 430.

Although not shown, a configuration example in which the opening portion 510 of the side wall portion 500 is provided together with the above-described inlet portion 350 (refer to FIG. 10 or FIG. 11) or instead of the inlet portion 350 is also conceivable.

The side wall portion 500 forms, together with other members, a space in the developing device 14 on the rear side of the paper surface of FIG. 13. In the space in the developing device 14 that is mentioned herein, a developer is likely to enter a state of floating in air as described above.

Since the opening portion 510 is provided at the side wall portion 500, a developer floating in the developing device 14 can be discharged as shown with an arrow 520 together with the suction mechanism shown in FIG. 6. In a case where a region in which it is particularly difficult to perform suction with the suction mechanism shown in FIG. 6 is present in the developing device 14, a developer floating in such a region is discharged through the opening portion 510, so that discharge of the developer floating in the developing device 14 is facilitated.

As shown in FIG. 13, a seal roll 530 is disposed below the facing member 430. The seal roll 530 is a non-magnetic member having a columnar shape and rotates in one direction. The seal roll 530 restricts toner adhering to the photoreceptor drum 11 from the facing member 430. The seal roll 530 encapsulates a developer floating in the developing device 14 such that the developer does not leak out of the developing device 14. The seal roll 530 is an example of a restricting portion.

Note that FIG. 13 also shows the above-described blocking member 160 positioned between the photoreceptor drum 11 and the developing device 14.

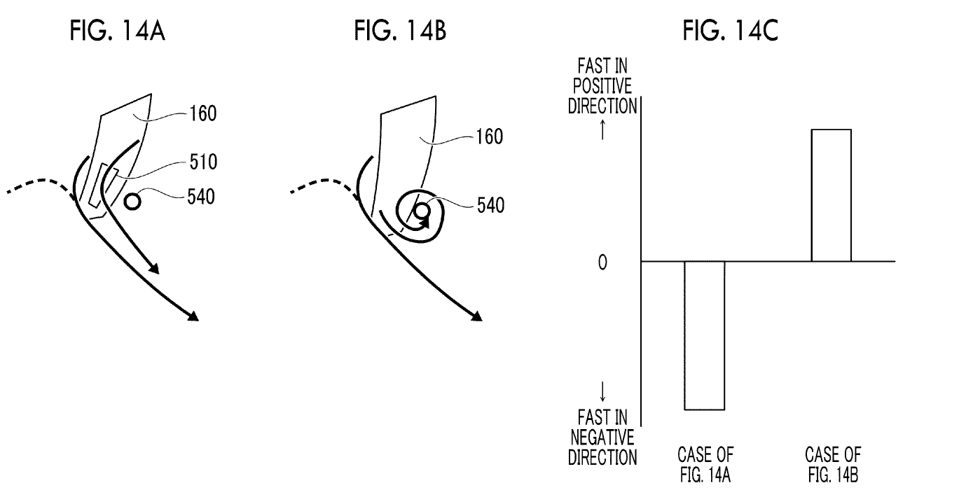

FIGS. 14A to 14C are views and a graph showing how air sucked in the vicinity of the blocking member 160 in the developing device 14 flows. FIG. 14A is a schematic view obtained by visualizing how air flows in the case of the present exemplary embodiment and FIG. 14B is schematic view obtained by visualizing how air flows in the case of a comparative example. FIG. 14C is a graph for description of a difference in wind speed between the cases of FIGS. 14A and 14B.

More specifically, FIGS. 14A and 14B show how air flows on each of a front side and a rear side of the blocking member 160. In FIGS. 14A and 14B, how air flows on the front side of the blocking member 160 is represented by a solid line and how air flows on the rear side of the blocking member 160 is represented by a thick line. FIGS. 14A and 14B are perspective views in which the blocking member 160 as seen from the rear side in a direction to the photoreceptor drum 11 is shown.

In addition, a vertical axis of the graph shown in FIG. 14C is a wind speed (m/s) in a suction direction at a region 540 which is set in advance on the rear side of the blocking member 160. The region 540 described herein is set in advance at a position with respect to the side wall portion 500 shown in FIG. 13.

The front side of the blocking member 160 mentioned herein means a side on which the photoreceptor drum 11 is installed and is the rear side of the paper surface of FIGS. 14A and 14B. The rear side of the blocking member 160 mentioned herein means an opposite side to, with respect to the blocking member 160, the side on which the photoreceptor drum 11 is installed and is the front side of the paper surface of FIGS. 14A and 14B. The rear side of the blocking member 160 means a side on which the above-described gap G provided between the blocking member 160 and the facing member 430 is.

In the present exemplary embodiment shown in FIG. 14A, as described above, the opening portion 510 is formed in the side wall portion 500 (refer to FIG. 13). As described above, in the present exemplary embodiment, the opening portion 510 is disposed on the opposite side to, with respect to the blocking member 160, the side on which the photoreceptor drum 11 (refer to FIG. 13) is installed.

However, in the comparative example shown in FIG. 14B, the opening portion 510 is not formed in the side wall portion 500. That is, the present exemplary embodiment is different from the comparative example, in which the opening portion 510 is not formed, in that the opening portion 510 is formed in the side wall portion 500.

As shown in FIG. 14A, in the present exemplary embodiment, air on the rear side of the blocking member 160 can be discharged through the opening portion 510 represented by a broken line. The air on the rear side of the blocking member 160 is sucked through the opening portion 510 of the side wall portion 500 (refer to FIG. 13) and merges with an air stream on the front side of the blocking member 160. That is, since the opening portion 510 is provided in the side wall portion 500, an air stream (side flow) at an outer surface of the side wall portion 500 can be generated. In addition, since the opening portion 510 provided in the side wall portion 500 is positioned on the rear side of the blocking member 160, stagnation of toner on the rear side of the blocking member 160 can be suppressed.

As described above, in the present exemplary embodiment, air on the rear side of the blocking member 160 can be discharged through the opening portion 510.

However, in the case of the comparative example shown in FIG. 14B, the opening portion 510 (refer to FIG. 13) is not provided in the side wall portion 500. Therefore, in the comparative example, air on the rear side of the blocking member 160 is less likely to merge with air on the front side of the blocking member 160 by being sucked, and thus the air is likely to become stagnant in the developing device 14 in comparison with the case of the present exemplary embodiment.

Due to such a difference between the present exemplary embodiment and the comparative example, there is a difference in wind speed in the suction direction as shown in FIG. 14C. A wind speed described herein refers to the wind speed of suction through the region 540 set in advance, and a direction along an arrow 550 (refer to FIG. 13) will be referred to as a positive direction, and a direction opposite to such a direction will be referred to as a negative direction.

As shown in FIG. 14C, in the case of FIG. 14B, air flows fast in the positive direction and in the case of FIG. 14A, air flows fast in the negative direction. In the case of FIG. 14B, air is restrained from flowing fast in the negative direction.

As described above, since the opening portion 510 is provided in the side wall portion 500 (refer to FIG. 13), stagnation of air on the rear side of the blocking member 160 is suppressed.

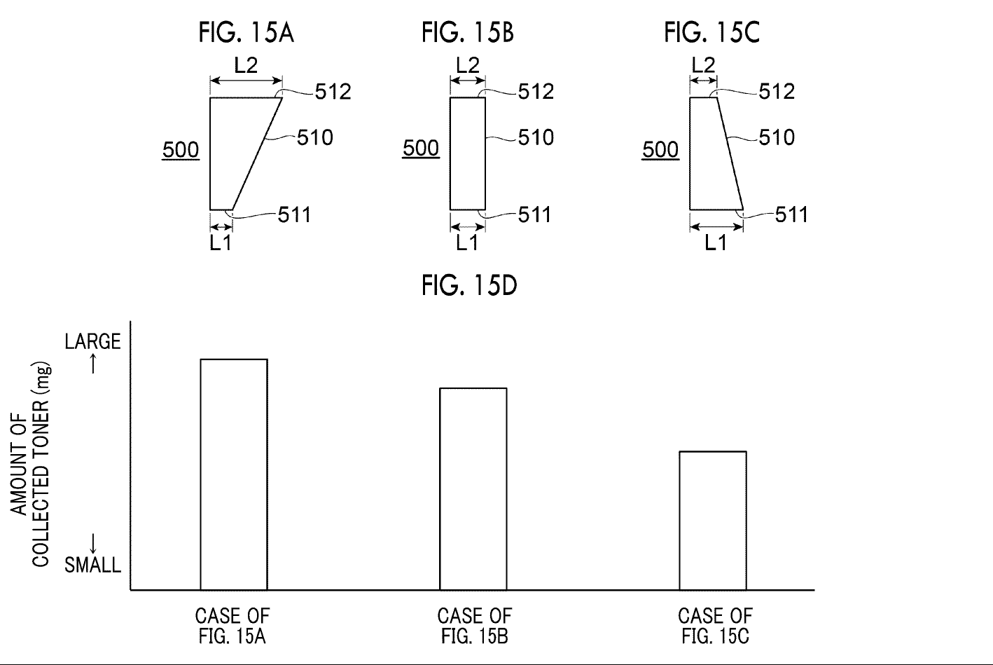

FIGS. 15A to 15D are views and a graph for description of the shape of the opening portion 510, where FIGS. 15A to 15C show various examples of the opening shape of the opening portion 510 and FIG. 15D is a graph showing the amounts of collected toner (mg) in the cases of FIGS. 15A to 15C, respectively.

An example of the opening shape of the opening portion 510 shown in FIG. 15A is a trapezoidal shape, and in a case where a length L1 of a lower base and a length L2 of an upper base are compared with each other, the length L2 of the upper base is larger than the length L1 of the lower base (L2 > L1). The lower base mentioned herein can be referred to as a lower side 511, and the upper base can be referred to as an upper side 512.

An example of the opening shape of the opening portion shown in FIG. 15B is a rectangular shape, and the length L1 of the lower side 511 and the length L2 of the upper side 512 are equal to each other (L2 = L1).

An example of the opening shape shown in FIG. 15C is a trapezoidal shape, and in a case where the length L1 of a lower base and the length L2 of an upper base are compared with each other, the length L2 of the upper base is smaller than the length L1 of the lower base (L2 < L1). The lower base mentioned herein can be referred to as the lower side 511, and the upper base can be referred to as the upper side 512.

As described above, FIGS. 15A to 15C are different from each other in length relationship between the length L1 of the lower side 511 and the length L2 of the upper side 512 and show three examples.

Regarding the result of calculation of the amount of collected toner (mg) in such examples, as shown in FIG. 15D, the amount of collected toner in the case of FIG. 15A is the largest. Note that the amount of collected toner in the case of FIG. 15C is the smallest and the amount of collected toner in the case of FIG. 15B is smaller than the amount of collected toner in the case of FIG. 15A and larger than the amount of collected toner in the case of FIG. 15C.

It is conceivable that a reason why the amount of collected toner in the case of the opening portion 510 shown in FIG. 15A is the largest is that toner is collected at the position of the upper side 512 at which the speed of a fall caused by the gravity is relatively low.

Note that in a case where the opening area of the opening portion 510 is small, the wind speed is increased and thus improvement in toner collection efficiency can be expected in comparison with a case where the opening area of the opening portion 510 is large.

Note that FIGS. 15A to 15C show cases where examples of the opening shape of the opening portion 510 are quadrangular shapes of which upper sides and lower sides are parallel to each other. However, the present invention is not limited thereto. For example, a case where an example of the opening shape is a quadrangular shape of which an upper side and a lower side are not parallel to each other is also conceivable. In addition, a case where an example of the opening shape is a polygonal shape other than a quadrangular shape is also conceivable. The polygonal shape mentioned herein means a figure surrounded by three or more line segments, and examples thereof include a triangular shape. In addition, examples of the polygonal shape mentioned herein include a pentagonal shape having an upper side and a lower side.

More specifically, an example in which an example of the opening shape has an upper side and a lower side and at least one of the upper side or the lower side extends in a horizontal direction is also conceivable.

In addition, another example in which an example of the opening shape of the opening portion 510 is an inverted right triangle is also conceivable. However, the amount of collected toner in the other example is smaller than the amount of collected toner in the case of FIG. 15C described above.

As described above, the opening portion 510 has a polygonal shape such as a quadrangular shape having an upper side and a lower side. For example, the opening portion 510 preferably has a polygonal shape of which an upper side has a length equal to or longer than the length of a lower side. More preferably, for example, the opening portion 510 has a polygonal shape of which an upper side is longer than a lower side.

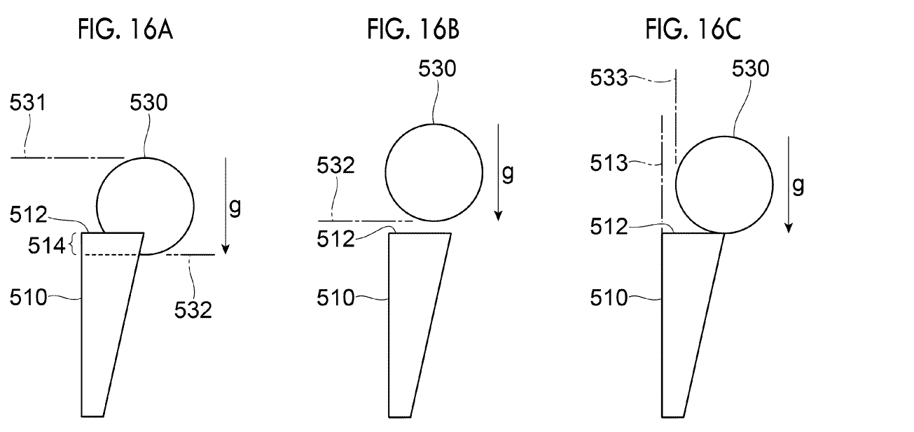

FIGS. 16A to 16C are views for description of a positional relationship between the seal roll 530 and the opening portion 510, where FIG. 16A shows a first example, FIG. 16B shows a second example, and FIG. 16C shows a third example. FIGS. 16A to 16C are views as seen in the axial direction (for example, refer to FIG. 3) of the facing member 430. More specifically, FIGS. 16A to 16C are views showing cases in each of which the developing device 14 is disposed such that the opening portion 150 faces the photoreceptor drum 11 side.

In the first example shown in FIG. 16A, the upper side 512 of the opening portion 510 is positioned closer to a lower side in a gravity direction g than the seal roll 530 is. More specifically, the upper side 512 is positioned closer to the lower side in the gravity direction g than the position of an uppermost surface 531 of the seal roll 530 in the gravity direction g is.

Note that in the first example, the upper side 512 is positioned closer to an upper side in the gravity direction g than the position of a lowermost surface 532 of the seal roll 530 in the gravity direction g is.

In addition, the upper side 512 is provided only in a region that does not overlap with the uppermost surface 531. That is, the upper side 512 of the opening portion 510 is not at the same position as the uppermost surface 531.

As described above, in the first example shown in FIG. 16A, a positional relationship, in which the upper side 512 of the opening portion 510 is positioned closer to the lower side in the gravity direction g than the position of the uppermost surface 531 is, is adopted.

In the second example shown in FIG. 16B, the upper side 512 of the opening portion 510 is provided only in a region that does not overlap with the seal roll 530. That is, the upper side 512 is positioned closer to the lower side in the gravity direction g than the seal roll 530 is. In other words, the upper side 512 is positioned closer to the lower side in the gravity direction g than the lowermost surface 532 of the seal roll 530 is.

In the case of FIG. 16B, it is possible to suck a large amount of toner falling due to the weight of the toner, in comparison with the case of FIG. 16A.

In the third example shown in FIG. 16C, a positional relationship between the seal roll 530 and the opening portion 510 regarding a direction intersecting the gravity direction is defined.

A left side 513 of the opening portion 510 is closer to a left side than a left end portion 533 of the seal roll 530 is. In other words, the left side 513 is closer to the photoreceptor drum 11 side than the left end portion 533 is.

In the case of FIG. 16C, toner falling from the seal roll 530 can be efficiently suctioned by means of air flow.

In FIG. 16C, the left side 513 of the opening portion 510 is an example of an end portion that is positioned on the photoreceptor drum 11 side in a direction intersecting the gravity direction. In addition, the left end portion 533 of the seal roll 530 is an example of an end portion positioned on the photoreceptor drum 11 side.

As described above and as shown in FIGS. 16A to 16C, the opening portion 510 of the side wall portion 500 is disposed closer to the lower side in the gravity direction g than the position of the uppermost surface 531 of the seal roll 530 is. Accordingly, it is possible to prevent a developer accumulating on the uppermost surface 531 of the seal roll 530 from being scattered by an air stream passing through the opening portion 510.

In addition, as shown in FIG. 16A, the opening portion 510 includes a portion 514 that is disposed closer to the upper side in the gravity direction g than the lowermost surface 532 of the seal roll 530 is.

Furthermore, as shown in FIG. 16B, the opening portion 510 is disposed closer to the lower side in the gravity direction g than the position of the lowermost surface 532 of the seal roll 530 is.

Furthermore, as shown in FIG. 16C, the left side 513 of the opening portion 510 is closer to the photoreceptor drum 11 side than the left end portion 533 of the seal roll 530 is, the left end portion 533 being on the photoreceptor drum 11 side.

In the above-described first and second examples shown in FIGS. 16A and 16B, positional relationships between the seal roll 530 and the opening portion 510 regarding the gravity direction are defined. In addition, in the third example shown in FIG. 6C, a positional relationship between the seal roll 530 and the opening portion 510 regarding a direction intersecting the gravity direction is defined.

Therefore, a combination of the first example and the third example is conceivable and a combination of the second example and the third example is also conceivable.

In a case where various configurations in the present exemplary embodiment as described above are adopted, contamination caused by toner in the developing device 14 can be suppressed by means of a small amount of wind without an increase in size of a suction unit sucking air.

Here, a modification example of the developing device 14 will be described.

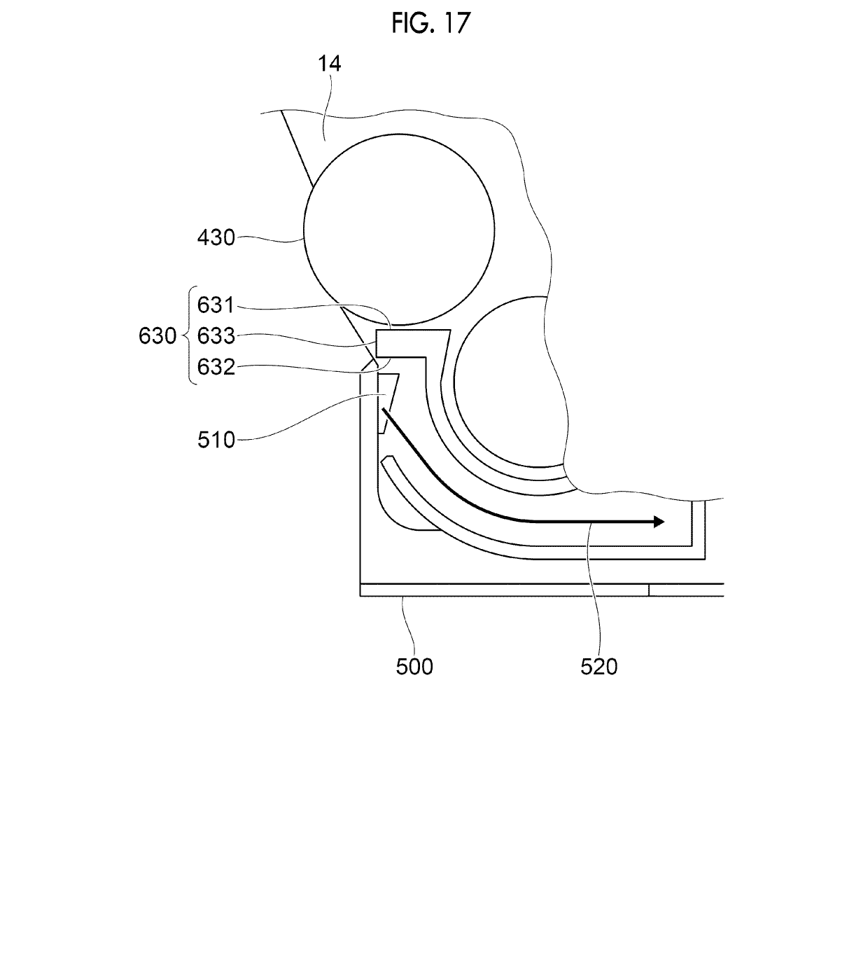

FIG. 17 is a view showing the modification example of the developing device 14 and corresponds to FIG. 13. In FIG. 17, since a configuration is the same as the configuration in FIG. 13, the same reference numerals are used for the same components. In addition, description of the same components may be omitted.

The developing device 14 according to the modification example shown in FIG. 17 is the same as the developing device 14 in the case of the present exemplary embodiment shown in FIG. 13 in that the opening portion 510 is formed in the side wall portion 500. However, the developing device 14 of FIG. 17 is different from the developing device 14 in the case of FIG. 13, in which the seal roll 530 is provided, in that a jaw-shaped portion 630 is provided.

More specifically, the jaw-shaped portion 630 is disposed at the position of the seal roll 530 (refer to FIG. 13). In other words, the jaw-shaped portion 630 is disposed instead of the seal roll 530.

The jaw-shaped portion 630 mentioned herein includes a portion that protrudes in a direction toward the photoreceptor drum 11. The jaw-shaped portion 630 receives toner falling from the facing member 430 with an upper surface. In addition, the jaw-shaped portion 630 restricts toner adhering to the photoreceptor drum 11 from the facing member 430. Furthermore, the jaw-shaped portion 630 prevents a developer floating in the developing device 14 from leaking out of the developing device 14.

The jaw-shaped portion 630 is an example of a restricting portion.

Not that in FIG. 17, the blocking member 160 shown in FIG. 13 is not shown.

As shown in FIG. 17, the jaw-shaped portion 630 includes an uppermost surface 631 in the gravity direction g, a lowermost surface 632 in the gravity direction g, and a left end portion 633 on the photoreceptor drum 11 side. The uppermost surface 631 of the jaw-shaped portion 630 corresponds to the uppermost surface 531 (refer to FIGS. 16A to 16C) of the seal roll 530. The lowermost surface 632 of the jaw-shaped portion 630 corresponds to the lowermost surface 532 (refer to FIGS. 16A to 16C) of the seal roll 530. The left end portion 633 of the jaw-shaped portion 630 corresponds to the left end portion 533 (refer to FIGS. 16A to 16C) of the seal roll 530.

Therefore, it is conceivable to apply contents described with reference to FIGS. 16A to 16C to the positional relationship between the jaw-shaped portion 630 and the opening portion 510.

Note that although the seal roll 530 (refer to FIG. 13) and the jaw-shaped portion 630 (refer to FIG. 17) have been described as examples of the restricting portion that restricts toner adhering to the photoreceptor drum 11, the present invention is not limited thereto. An example in which, for example, a metal blade scraper is provided as an example of the restricting portion is also conceivable.

Although the exemplary embodiment of the present invention has been described above, the technical scope of the exemplary embodiment of the present invention is not limited to the above exemplary embodiment. In addition, various modifications and alternative configurations are involved in the present invention without departing from the technical scope of the present invention.

### Supplementary Note

1

A developing device that is composed of a plurality of constituent members and that causes a developer to adhere to an image holding body holding an image, the developing device comprising:

an opening that is disposed in a state of facing an image holding body side;

a blocking member that partially blocks the opening; and

another opening that extends in a direction intersecting a surface of the opening and that is disposed on an opposite side to, with respect to the blocking member, a side on which the image holding body is installed,

wherein air on the opposite side is dischargeable through the other opening.

2

The developing device according to (((1))),

wherein the other opening is disposed below a highest position on a restricting portion in a case where the opening is disposed in the state of facing the image holding body side, the restricting portion restricting the developer adhering to the image holding body.

3

The developing device according to 2,

wherein the other opening disposed below the highest position includes a portion that is disposed above a lowest position on the restricting portion in a case where the opening is disposed in the state of facing the image holding body side.

4

The developing device according to 2,

wherein the other opening disposed below the highest position is disposed below a lowest position on the restricting portion in a case where the opening is disposed in the state of facing the image holding body side.

5

The developing device according to any one of 2 to 4,

wherein an end portion of the other opening that is positioned on the image holding body side in the direction intersecting the surface of the opening is closer to the image holding body side than an end portion of the restricting portion that is positioned on the image holding body side in the direction intersecting the surface of the opening is.

6

The developing device according to any one of 1 to 5 ,

wherein the other opening has a polygonal shape having an upper side and a lower side.

7

The developing device according to 6 ,

wherein the upper side of the polygonal shape has a length equal to or larger than a length of the lower side.

8

The developing device according to 7,

wherein the upper side is longer than the lower side.

9

An image forming apparatus comprising:

the developing device according to any one of 1 to 8.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device that is composed of a plurality of constituent members and that causes a developer to adhere to an image holding body holding an image, the developing device comprising:
an opening that is disposed in a state of facing an image holding body side;
a blocking member that partially blocks the opening; and
another opening that extends in a direction intersecting a surface of the opening and that is disposed on an opposite side to, with respect to the blocking member, a side on which the image holding body is installed,
wherein air on the opposite side is dischargeable through the other opening.

2. The developing device according to claim 1,
wherein the other opening is disposed below a highest position on a restricting portion in a case where the opening is disposed in the state of facing the image holding body side, the restricting portion restricting the developer adhering to the image holding body.

3. The developing device according to claim 2,
wherein the other opening disposed below the highest position includes a portion that is disposed above a lowest position on the restricting portion in a case where the opening is disposed in the state of facing the image holding body side.

4. The developing device according to claim 2,
wherein the other opening disposed below the highest position is disposed below a lowest position on the restricting portion in a case where the opening is disposed in the state of facing the image holding body side.

5. The developing device according to claim 2,
wherein an end portion of the other opening that is positioned on the image holding body side in the direction intersecting the surface of the opening is closer to the image holding body side than an end portion of the restricting portion that is positioned on the image holding body side in the direction intersecting the surface of the opening is.

6. The developing device according to claim 1,
wherein the other opening has a polygonal shape having an upper side and a lower side.

7. The developing device according to claim 6,
wherein the upper side of the polygonal shape has a length equal to or larger than a length of the lower side.

8. The developing device according to claim 7,
wherein the upper side is longer than the lower side.

9. An image forming apparatus comprising:
the developing device according to claim 1.

10. An image forming apparatus comprising:
the developing device according to claim 2.

11. An image forming apparatus comprising:
the developing device according to claim 3.

12. An image forming apparatus comprising:
the developing device according to claim 4.

13. An image forming apparatus comprising:
the developing device according to claim 5.

14. An image forming apparatus comprising:
the developing device according to claim 6.

15. An image forming apparatus comprising:
the developing device according to claim 7.

16. An image forming apparatus comprising:
the developing device according to claim 8.
